(19) United States
(12) Patent Application Publication
(10) Pub. No.: US 2016/0350116 A1
(43) Pub. Date: Dec. 1, 2016

(54) MITIGATING WRONG-PATH EFFECTS IN BRANCH PREDICTION

(71) Applicant: QUALCOMM Incorporated, San Diego, CA (US)

(72) Inventors: Vimal Kodandarama REDDY, Cary, NC (US); Niket Kumar CHOUNDHARY, Raleigh, NC (US); Michael Scott MCILVAINE, Raleigh, NC (US); Daren Eugene STREETT, Cary, NC (US); Robert Douglas CLANCY, Cary, NC (US); James Norris DIEFFENDERFER, Apex, NC (US); Michael William MORROW, Wilkes-Barre, PA (US)

(21) Appl. No.: 14/726,450

(22) Filed: May 29, 2015

(51) Int. Cl. G06F 9/38; G06F 9/30

(52) U.S. Cl. CPC G06F 9/3806; G06F 9/30058

(57) ABSTRACT

Systems and methods for mitigating influence of wrong-path branch instructions in branch prediction include a branch prediction write queue. A first entry of the branch prediction write queue is associated with a first branch instruction based on an order in which the first branch instruction is fetched. Upon speculatively executing the first branch instruction, a correct direction of the first branch instruction is written in the first entry. Prior to committing the first branch instruction, the branch prediction write queue is configured to update one or more branch prediction mechanisms based on the first entry if the first branch instruction was speculatively executed in a correct-path. Updates to the one or more branch prediction mechanisms based on the first entry are prevented if the first branch instruction was speculatively executed in a wrong-path.

### FIELD OF DISCLOSURE

Disclosed aspects relate to branch prediction techniques, and more specifically, techniques for mitigating undesirable effects caused by wrong-path branches in branch prediction.

### BACKGROUND

Conditional branch instructions may be employed by processors. The actual branch direction of a conditional branch instruction is based on how a condition evaluates. However, the evaluation may only be known deep in an instruction pipeline of a processor. To avoid stalling the pipeline until the evaluation is known, the processor may employ branch prediction mechanisms to predict the direction of the conditional branch instruction early in the pipeline. Based on the prediction, the processor can speculatively fetch and execute instructions from a predicted address in one of two paths—a “taken” path which starts at the branch target address, or a “not-taken” path which starts at the next sequential address after the conditional branch instruction. When the condition is evaluated and the actual branch direction is determined, if the branch was mispredicted, (i.e., execution followed the wrong path) the speculatively fetched instructions need to be flushed from the pipeline, and new instructions will need to be fetched from the correct next address. Speculatively fetched instructions in the wrong path (or “wrong-path” instructions), may include wrong-path branch instructions. The wrong-path branch instructions can negatively impact branch prediction mechanisms.

For example, branch prediction mechanisms may include one or more state machines which may be trained based on a history of evaluation of past and current branch instructions. Updates from wrong-path branch instructions cause the state machine to be incorrectly trained, thus hampering accuracy of the branch prediction mechanisms. Therefore it is important to prevent the wrong-path branch instructions from corrupting the branch prediction mechanisms.

However, conventional processors which support out-of-order execution find it difficult to selectively prevent wrong-path branch instructions from updating the branch prediction state machine. This is because it may not be possible to identify at the time of execution of a branch instruction, whether or not the branch instruction is in a wrong-path due to an older branch instruction having been mispredicted. In order to guarantee that a particular branch instruction executed in a wrong-path does not corrupt the state machine, the corresponding branch prediction for the branch instruction will need to be withheld from updating the state machine until the branch instruction has committed. However, delaying update of the state machine until the time the branch instruction commits will degrade performance because the training of the state machine will be delayed. Some conventional techniques nevertheless delay the update of the state machine until the branch instruction commits, but attempt to make up for the lost performance by performing an associative lookup of the state machine. However, such conventional techniques tend to be expensive in terms of area and power since the associative lookup has to be performed every clock cycle.

Accordingly, there is a continuing need to effectively and efficiently avoid the corruption of branch prediction mechanisms by wrong-path branch instructions.

### SUMMARY

Exemplary aspects are directed to systems and methods for mitigating influence of wrong-path branch instructions in branch prediction branch prediction include a branch prediction write queue. The branch prediction write queue is configured to order branch prediction updates from branch instructions in an out-of-order processor, without waiting for the branch instructions to commit, while preventing wrong-path branch instructions from training branch prediction mechanisms. In one aspect, a first entry of the branch prediction write queue is associated with a first branch instruction based on an order in which the first branch instruction is fetched. Upon speculatively executing the first branch instruction, a correct direction of the first branch instruction is written in the first entry. Prior to committing the first branch instruction, the branch prediction write queue is configured to update one or more branch prediction mechanisms based on the first entry if the first branch instruction was speculatively executed in a correct-path. Updates to the one or more branch prediction mechanisms based on the first entry are prevented if the first branch instruction was speculatively executed in a wrong-path.

For example, an exemplary aspect is directed to a method of operating a processor, the method comprising: upon speculatively executing a first branch instruction, writing a direction of the first branch instruction in a first entry of a branch prediction write queue, the first entry associated with the first branch instruction based on an order in which the first branch instruction was fetched. The method includes updating one or more branch prediction mechanisms based on the first entry if the first branch instruction was speculatively executed in a correct-path, and preventing updates to the one or more branch prediction mechanisms based on the first entry if the first branch instruction was speculatively executed in a wrong-path.

Another exemplary aspect is directed to a processor comprising an instruction pipeline to speculatively execute a first branch instruction. A branch prediction write queue is configured to include a first entry to store a direction of the first branch instruction, the first entry associated with the first branch instruction based on an order in which the first branch instruction was fetched in the instruction pipeline. The branch prediction write queue is configured to update one or more branch prediction mechanisms based on the first entry if the first branch instruction was speculatively executed in a correct-path, and to prevent updates to the one or more branch prediction mechanisms based on the first entry if the first branch instruction was speculatively executed in a wrong-path

Yet another exemplary aspect is directed to a processing system comprising means for speculatively executing a first branch instruction, means for storing a direction of the first branch instruction in an order in which the first branch instruction was fetched, means for updating one or more branch prediction mechanisms based on the stored direction of the first branch instruction if the first branch instruction was speculatively executed in a correct-path, and means for preventing updates to the one or more branch prediction mechanisms based on the stored direction of the first branch instruction if the first branch instruction was speculatively executed in a wrong-path.

Another exemplary aspect is directed to a non-transitory computer readable storage medium comprising code, which, when executed a processor, causes the processor to perform operations for preventing wrong-path updates to branch prediction mechanisms, the non-transitory computer readable storage medium comprising code for speculatively executing a first branch instruction, code for writing a direction of the first branch instruction in a first entry of a branch prediction write queue, the first entry associated with the first branch instruction based on an order in which the first branch instruction was fetched, code for updating one or more branch prediction mechanisms based on the first entry if the first branch instruction was speculatively executed in a correct-path; and code for preventing updates to the one or more branch prediction mechanisms based on the first entry if the first branch instruction was speculatively executed in a wrong-path.

### BRIEF DESCRIPTION OF THE DRAWINGS

The accompanying drawings are presented to aid in the description of aspects of the invention and are provided solely for illustration of the aspects and not limitation thereof.

FIG. 1 illustrates a block diagram of a processing system configured according to disclosed aspects.

FIG. 2 illustrates an exemplary branch prediction write queue configured according to aspects of this disclosure.

FIGS. 3A-B illustrate operational flow-charts for methods of operating a processor according to exemplary aspects.

FIG. 4 illustrates an exemplary wireless device in which an aspect of the disclosure may be advantageously employed.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

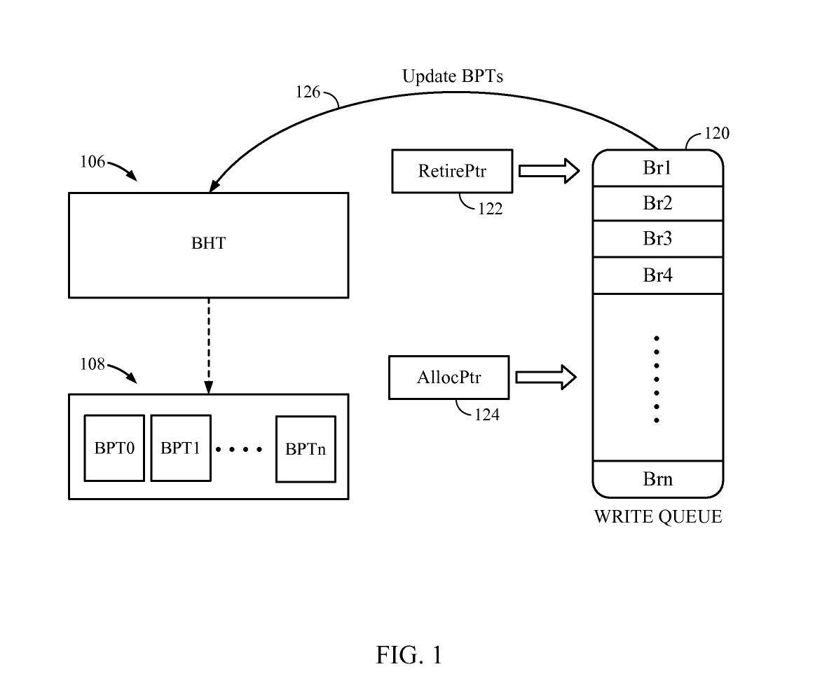

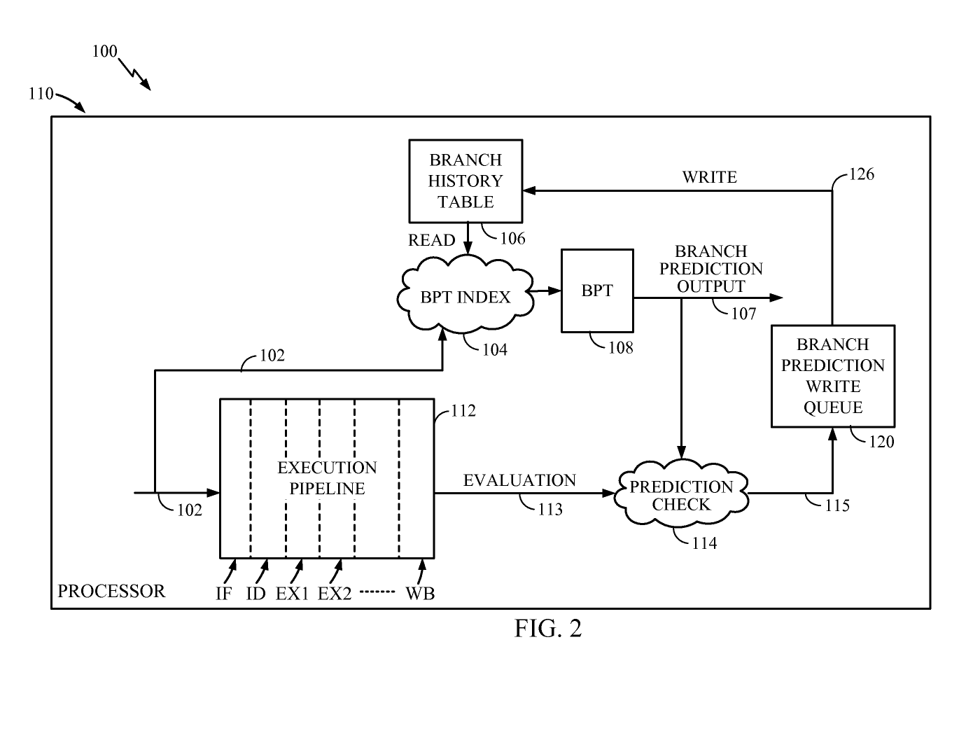

As described herein, a first branch instruction may have been speculatively executed in a correct-path if an older branch instruction fetched before the first branch instruction was not mispredicted. On the other hand, the first branch instruction may have been speculatively executed in a wrong-path if an older branch instruction fetched before the first branch instruction was mispredicted. In exemplary aspects, a branch prediction write queue is used to order updates from branch instructions in the order they were fetched and accordingly avoid wrong-path updates to the branch prediction mechanisms. Accordingly, the branch prediction write queue is configured to allow updates to one or more branch prediction mechanisms based on a direction of the first branch instruction if the first branch instruction was speculatively executed in a correct-path and prevent updates to the one or more branch prediction mechanisms based on a direction of the first branch instruction if the first branch instruction was speculatively executed in a wrong-path. An example implementation of the branch prediction write queue is described with reference to FIGS. 1 and 2 below.

With reference to FIG. 1 an exemplary branch prediction write queue 120 configured according to exemplary aspects is illustrated. Branch prediction write queue 120 may be coupled to one or more branch prediction mechanisms. In FIG. 1, the branch prediction mechanisms include a branch history storage mechanism such as a branch history table (BHT) 106 and associated one or more branch prediction state machines, e.g., a branch prediction table (BPT) 108. As will be explained with reference to FIG. 2 below, branch prediction write queue 120, BHT 106 and BPT 108 may belong to processor 110 which supports out-of-order (000) execution.

Branch prediction write queue 120 may be a circular stack or buffer comprising a plurality of entries denoted as Br1, Br2, Br3, and Br4 which correspond to a first branch instruction, a second branch instruction, a third branch instruction, and a fourth branch instruction, respectively. In one example, the first branch instruction may be the oldest (in program order) and the fourth branch instruction may be the youngest (in program order) of the four branch instructions. Two pointers comprising a first pointer, shown as allocation pointer 124 and a second pointer, shown as retirement pointer 122 are associated with the entries. These two pointers are used to arrange, in program order, information obtained from speculative execution of the four branch instructions out-of-order.

A particular entry of branch prediction write queue 120, which is pointed to by allocation pointer 124 when a branch instruction is fetched, is associated with the branch instruction. However, there are no writes performed to the particular entry by the branch instruction at this point. Rather, the branch instruction remembers that entry in order to write or update that remembered entry after the execution of the branch instruction is completed. Once the particular entry pointed to by allocation pointer 124 is associated with a branch instruction in this manner at fetch time of the branch instruction, allocation pointer 124 is incremented to point to a next entry to be associated with the next branch instruction which is fetched. Accordingly, when the first branch instruction is fetched, allocation pointer 124 would have pointed to the first entry Br1, which would be associated with the first branch instruction. Allocation pointer 124 will then be incremented to point to the second entry Br2, which is associated with the second branch instruction when the second branch instruction is fetched. Similarly, allocation pointer 124 would have pointed to Br3 and Br4 respectively, when the third and fourth branch instructions were fetched, and these entries will be remembered by the third and fourth branch instructions, respectively, as they execute. The younger, second entry Br2 is said to be logically one after the older, first entry Br1. Similarly, the second entry Br2 is logically one before the even younger third entry Br3, and so on. As previously noted, once entries pointed to by allocation pointer 124 are associated with each new branch instruction that is fetched, allocation pointer 124 will be incremented. At the time instance shown, allocation pointer 124 is pointing to a generic entry after having been incremented past Br4.

The entries Br1, Br2, Br3, and Br4 of branch prediction write queue 120 are written by corresponding branch instructions as soon as their respective execution (which may be speculative) is completed. In out-of-order execution, even though the second branch instruction is fetched after the first branch instruction, speculative execution of the second branch instruction may be completed before the speculative execution of the first branch instruction is completed. In this illustration, since the first branch instruction is the oldest, it will not be known until execution of the first branch instruction is completed, whether or not the first branch instruction was correctly executed. In other words, until execution of the first branch instruction is completed, it will not be known whether the second branch instruction was speculatively executed in a correct-path or a wrong-path. Thus, even though execution results of the branch instructions are written to corresponding entries as soon as execution is complete, the entries of branch prediction write queue 120 may not be used to update the one or more branch prediction mechanisms (e.g., BHT 106 and BPT 108) as soon as the entries have been written. In order to prevent updates to the branch prediction mechanisms from entries as soon as they are written, retirement pointer 122 is used in conjunction with allocation pointer 124. Retirement pointer 122 always points to an oldest entry which was written by a correct-path branch instruction. The entry pointed to by retirement pointer 122 is referred to as a retirement entry. Once the retirement entry is written by a correct-path branch instruction, the retirement entry may be used to update the branch prediction mechanisms.

It will be understood that the correct direction of branch instructions which executed in the correct-path as well as those that executed in the wrong-path will be written to branch prediction write queue 120; however, only the directions of only correct-path branch instructions will be allowed to update the branch prediction mechanism comprising BHT 106 and BPT 108, whereas the directions of wrong-path branch instructions will not be allowed to update the branch prediction mechanism.

When the first branch instruction is executed and the result of execution of the first branch instruction is obtained, the correct direction (taken/not-taken) as well as whether the first branch instruction was correctly predicted or mispredicted will be known. In this example, since the first branch instruction is the oldest branch instruction, it will be assumed to be in a correct-path by default (whether or not the first branch instruction itself is correctly predicted or mispredicted). Along with writing to the entry Br1, the correct direction (taken/not-taken) for the first branch instruction, a status bit may be set to indicate that the Br1 has been written. If the first branch instruction was mispredicted, then the younger second, third, and fourth branch instructions would have been executed down a wrong-path. To prevent updates from these wrong-path branch instructions from updating BHT 106 and BPT 108, allocation pointer 124 will be restored to Br2 if the first branch instruction mispredicted. Restoring allocation pointer 124 in this manner to the second entry Br2 means that any updates from wrong-path branch instructions which were fetched after the first branch instruction (corresponding to subsequent entries Br2, Br3, Br4, etc., in the branch prediction write queue) will need to be flushed. Therefore, restoring allocation pointer 124 to the second entry Br2 causes flushing writes in branch prediction write queue 120 from wrong-path branch instructions comprising programmatically younger instructions which were fetched after the first branch instruction. Thus, any updates of BHT 106 from entries Br2, Br3, and Br4 would be prevented by restoring allocation pointer 124 back to Br2. The status bit of Br2 (and subsequent entries Br3, Br4, etc.) may be cleared when allocation pointer 124 is restored to Br2.

Retirement pointer 122 is used for effecting updates of BHT 106, BPT 108 through update path 126 as follows. Retirement pointer 122 points to the oldest entry of branch prediction write queue 120 which was correctly updated. An entry pointed to by retirement pointer 122 is scanned every clock cycle (of processor 110 of FIG. 2, for example) to check if that entry has been written (e.g., based on the aforementioned status bit being set). When the entry pointed to by retirement pointer 122 is written, the contents of the entry (e.g., an indication of taken/not-taken, any other accompanying branch prediction state, etc.) are transferred from update path 126 to update the corresponding entry or state machine for that branch in BHT 106. For example, when the first branch instruction is executed and its prediction is evaluated, the result is written to entry Br1. In FIG. 1, retirement pointer 122 is shown to be pointing to Br1. Thus, Br1 would be scanned every cycle, and when Br1 is written, retirement logic (not shown) of branch prediction write queue 120 would detect a write to Br1 and update the branch prediction mechanisms BHT 106 and BPT 108 (in the same clock cycle or the following clock cycle, based on specific implementations). Once the entry Br1 has been used to update the branch prediction mechanism, retirement pointer 122 is incremented to point to the next entry, Br2, for example. If the first branch instruction mispredicted then allocation pointer 124 would be restored to Br2. In this manner, the branch prediction mechanisms are guaranteed to be updated only by correct-path branch instructions (because any updates from wrong-path branch instructions will be flushed).

It will be noticed that branch prediction write queue 120 may be used to update the one or more branch prediction mechanisms soon after a branch instruction's execution is completed, but before the branch instruction is committed. To explain this, once execution of the second branch instruction, for example, is completed, the results of the second branch instruction will remain in the second entry Br2 of branch prediction write queue 120 until older instructions such as the first branch instruction have completed their execution and their results are written back, for example, to a register file (in addition to updating branch prediction mechanisms as necessary). This write back to a register file is also known as committing or retiring the branch instructions. There may be several clock cycles of delay from when the execution of the second branch instruction is completed to when the second branch instruction is committed/retired (e.g., based on when the first branch instruction completed execution). However, since in exemplary aspects, the update of the branch prediction mechanism can happen soon after execution of the second branch instruction is completed (e.g., in cases where the second branch instruction is in a correct-path and retirement pointer 122 points to the second branch instruction soon after execution of the second branch instruction is completed), the update of the branch prediction mechanisms need not be delayed until the second branch instruction is committed/retired. This leads to an improvement in the rate or speed at which the branch prediction mechanism is correctly updated, while avoiding wrong-path updates.

In this manner, branch prediction write queue 120 helps to order updates to branch prediction mechanisms in an out-of-order processor, by not allowing younger branch instructions which may be in a wrong-path to update the branch prediction mechanisms before it is confirmed that older branch instructions were not mispredicted. For example, retirement pointer 122 will point to what the entry known as a “retirement entry,” which corresponds to the oldest branch instruction in the pipeline at any given time. Retirement pointer 122 is incremented (i.e., to point to a younger branch instruction) if the retirement entry is written with the correct direction of the oldest branch instruction and the oldest branch instruction is a correct-path branch instruction. Once incremented, the retirement entry becomes the new entry to which retirement pointer 122 points, and so on. The retirement entry will not be flushed due to misprediction of a younger branch instruction.

With reference now to FIG. 2, a schematic representation of processing system 100 configured according to exemplary aspects, comprising branch prediction write queue 120. In more detail, processing system 100 includes processor 110, which may be communicatively coupled to memory structures including an instruction cache (not shown). Processor 110 may be an out-of-order processor, or in other words, support out-of-order execution of instructions. Processor 110 may be configured to receive instructions such as instruction 102 from the instruction cache and execute the instructions out-of-order using instruction pipeline 112 for example. Instruction pipeline 112 may include one or more pipeline stages, representatively illustrated as the pipeline stages: instruction fetch (IF), instruction decode (ID), one or more execution stages EX1, EX2, etc., and a write back (WB) stage. Skilled persons will recognize numerous modifications and additions to instruction pipeline 112, as known in the art. Processor 110 may also be coupled to numerous other components (such as data caches, IO devices, memory, etc.) which have not been explicitly shown or described herein for the sake of simplicity.

In exemplary aspects, processor 110 includes dynamic branch prediction tracking mechanisms including branch history table (BHT) 106, branch prediction table (BPT) 108 along with BPT index 104, and branch prediction write queue 120 discussed above. BHT 106 may store a history of predictions/evaluations of conditional branch instructions (e.g., a pattern of taken/not-taken) that traverse or have traversed through instruction pipeline 112, for example. In an example implementation, BHT 106 may store a history or pattern of taken/not-taken evaluations for m branch instructions. BPT 108 may maintain n state machines (e.g., 2-bit saturating counters, as known in the art) BPT0, BPT1 . . . BPTn. The numbers m and n may be chosen based on particular implementations and need not be equal. Each one of the n state machines may correspond to a function of the pattern of m taken/not-taken evaluations/predictions in BHT 106. BPT index 104 (shown in FIG. 1) may be used to index into BPT 108 based on inputs such as the PC of instruction 102 and the pattern stored in BHT 106. In an example, each one of the first, second, third, and fourth branch instructions discussed above may potentially update an entry of BHT 106 and one or more state machines BPT0, BPT1 . . . BPTn of BPT 108, if they are in the correct-path. Updates to BPT 108 may be based on the patterns of predictions/evaluations that are stored in BHT 106 for these branch instructions. Updates of BHT 106 and, correspondingly, BPT 108 may be performed through update path 126 for only correct-path branch instructions while avoiding updates from wrong-path branch instructions using branch prediction write queue 120 as described with reference to FIG. 1.

The cooperation of branch prediction write queue 120 with the various other illustrated components of processor 110 will now be described. In one exemplary aspect, instruction 102 shown in FIG. 2 may represent the first branch instruction (e.g., fetched from the instruction cache in the IF stage of instruction pipeline 112). At this stage, allocation pointer 124 may be pointing to the first entry Br1 (shown in FIG. 1). The value of allocation pointer 124 (i.e. an index to the first entry Br1) is obtained and associated with the first branch instruction. After being associated with the first branch instruction, allocation pointer 124 will be incremented by one, for example, to point to the second entry Br2 as previously described. In general, the second entry being an index value which is logically one index value following the first entry means that if the first entry is any entry but the bottom-most entry, the second entry would be the “first entry+1”; and if the first entry is the bottom-most entry, then the second entry may wraparound and be the top-most entry.

In parallel to the above processes of fetching the first branch instruction into instruction pipeline 112 and obtaining the value of allocation pointer 124, the pattern stored in BHT 106 and instruction 102 may be used by BPT index 104 to access BPT 108 and obtain branch prediction output 107. Branch prediction output 107 may become available one or more clock cycles later, and may be provided as an input to instruction pipeline 112 in an early execution stage such as the EX1 stage of instruction pipeline 112. Using branch prediction output 107, the direction or path of branch instructions may be predicted as taken/not-taken, and the first branch instruction may be speculatively executed down the determined path. Branch prediction output 107 may also be used to speculatively fetch newer instructions from the instruction cache (not shown).

Once the actual evaluation of the first branch instruction is obtained one or more clock cycles later (e.g., at an execution stage such as EX2, or EX3 of instruction pipeline 112) the evaluation or the correct direction (taken/not-taken) for the first branch instruction may be output from instruction pipeline 112 as evaluation 113. Prediction check block 114 may be provided as a logic block (e.g., implementing a comparator) to accept evaluation 113 as one input and branch prediction output 107 as another input to check if the prediction and actual evaluation match. Result 115 is generated by prediction check block 114, which includes the correct direction (i.e., taken/not-taken), as well as an indication of whether the branch instruction was correctly predicted or whether it was mispredicted. Thus, upon speculative execution of the first branch instruction, information pertaining to the direction of the first branch instruction (e.g., whether the branch was correctly predicted or mispredicted and the correct direction, taken/not-taken) as obtained from result 115 is provided to branch prediction write queue 120, along with the value of allocation pointer 124 associated with the first branch instruction (i.e., pointing to the first entry Br1 of branch prediction write queue 120). The correct direction of the first branch instruction is written to the first entry Br1 of branch prediction write queue 120. An associated status bit may be set to indicate that the first entry Br1 has been written.

If result 115 shows that branch prediction output 107 and evaluation 113 match, then the first branch instruction was correctly predicted. A younger, second branch instruction that was fetched after the first branch instruction would thus have been executed in a correct-path (even if the second branch instruction itself was mispredicted). The direction of the first branch instruction (taken/not-taken) may then be used to update branch prediction mechanisms including BHT 106 and BPT 108.

If result 115 shows that there was a mismatch between branch prediction output 107 and evaluation 113, then the first branch instruction would have been mispredicted. Any instructions that were speculatively executed following the speculative execution of the first branch instruction will need to be flushed and prevented from writing back or committing in pipeline stage WB. In exemplary aspects where execution pipeline 112 is an out-of-order execution pipeline, then it is possible for the younger second branch instruction, which was fetched after the first branch instruction, to be executed before the first branch instruction and to write to branch prediction write queue 120 before it is discovered that the first branch instruction had mispredicted and thus, the write from the second branch instruction needs to be flushed. Thus, in case the first branch instruction was mispredicted, the second branch instruction would have executed down the wrong-path. Writes to branch prediction write queue 120 from the wrong-path second branch instruction are prevented from training BHT 106 and BPT 108 based on restoring allocation pointer 124 to the second entry Br2 as previously described.

Thus in general, upon speculatively executing the first branch instruction a direction of the first branch instruction can be stored in the first entry Br1 of branch prediction write queue 120, where the first entry is associated with the first branch instruction in an order in which the first branch instruction was fetched (e.g., based on associating a first entry in branch prediction write queue 120 to which the allocation pointer points when the first branch instruction was fetched). One or more branch prediction mechanisms may then be updated based on the first information if the first branch instruction was speculatively executed in a correct-path (e.g., if the first entry has been written and has not been flushed from branch prediction write queue 120 when a retirement pointer points to the first entry), while preventing updates to the one or more branch prediction mechanisms based on the first entry if the first branch instruction was speculatively executed in a wrong-path (e.g., if a branch instruction older than the first branch instruction had been mispredicted, then the first branch instruction would have been executed in a wrong-path and by restoring the allocation pointer to an entry logically equal to or before the first entry upon the older branch instruction's misprediction, the first entry would have been flushed).

It will be noted that when an entry in branch prediction write queue 120 is written with the correct direction of a branch instruction as obtained from result 115, for example, that entry becomes a candidate to write or update the branch prediction mechanisms. It has been described that wrong-path writes are flushed from branch predictor write queue 120 by restoring allocation pointer 124. Additionally, it will be understood that updates of the branch prediction mechanisms from entries in branch prediction write queue 120 which have been written but are not yet confirmed to be writes from correct-path branch instructions are also blocked since only entries that are pointed to by retirement pointer 122 can be used to update the branch prediction mechanisms.

Accordingly it is seen that updates to BHT 106 and BPT 108 are made in an orderly fashion from the oldest correct-path branch instruction to the youngest correct-path branch instruction, while preventing any updates from branch instructions fetched and executed in a wrong-path. Further, as seen from the above discussion, updates from branch instructions which are not in a wrong-path (i.e., are in the correct-path) are allowed to update BHT 106 and BPT 108 without waiting for them to commit (e.g., in WB stage of instruction pipeline 112). In many cases, this could mean a saving of several clock cycles which can improve overall processing speed because BHT 106 and BPT 108 may be trained correctly earlier, and thus used in the correct prediction of a following branch.

As previously noted, branch prediction write queue 120 may be implemented as a circular buffer where the pointers wraparound. For example, if allocation pointer 124 reaches the bottom-most entry (e.g., the entry shown to be associated with an n^{th} branch instruction Brn) of branch prediction write queue 120, then it may wraparound to the top-most entry of branch prediction write queue 120. Wraparounds do not pose a problem as long as allocation pointer 124 does not wraparound and move past or wrap over retirement pointer 122.

However, allocation pointer 124 may wrap over retirement pointer 122, if the execution of the oldest branch instruction (e.g., whose allocation pointer 124 points to entry Br1 in branch prediction write queue 120) takes a long time to complete, for example, due to dependency on a long-latency instruction or event. It is possible in this scenario that instructions including branch instructions continue to be fetched and associated with allocation pointer 124 which correspondingly continue to be incremented. For example, if more than n−1 branch instructions are fetched after the oldest/first branch instruction before execution of the first branch instruction is complete, then allocation pointer 124 may align with retirement pointer 122 (e.g., pointing to the entry Br1) or wrap over retirement pointer 122. In order to explain the process by which such wraparound scenarios are handled, it is useful to designate branch instructions as belonging to two groups. A first group of branch instructions includes all the branch instructions prior to the wraparound (i.e., n branch instructions which are first associated with allocation pointer 124 pointing to entries Br1-Brn in this example). A second group of branch instructions includes all the branch instructions which are associated with allocation pointer 124, post wraparound (i.e., any branch instruction fetched after allocation pointer 124 pointed to Brn, pre-wraparound and for which allocation pointer 124 wraps around starting with pointing to the top-most entry Br1 of branch prediction write queue 120 again).

If all of the newly fetched branch instructions in the second group (i.e., post-wraparound), execute after the older, branch instructions in the first group (i.e., pre-wraparound), then the processes described above for effecting updates to BHT 106 and BPT 108 using branch predictor write queue 120 remain the same. This is because entries of branch predictor write queue 120 will only be written upon execution of the branch instructions and the second group will not overwrite any entries written by the first group by virtue of the executions of the second group being completed later.

However, since processor 110 may be an out-of-order processor, it is possible for one or more branch instructions in the second group to execute before branch instructions in the second group. Since there is a wraparound, a value of allocation pointer 124 (e.g., pointing to a fifth entry Br5 (not shown) of branch prediction write queue 120) may be shared by one instruction of the first group and one instruction of the second group. If for example, execution of a branch instruction of the second group whose associated allocation pointer 124 points to the fifth entry Br5 completes before a branch instruction of the first group whose associated allocation pointer 124 also points to the fifth entry Br5, then the branch instruction from the second group can write to the fifth entry Br5 before the branch instruction from the first group writes to the fifth entry Br5. This can lead to two undesirable situations. Firstly, some updates to branch prediction write queue 120 from branch instructions in the first group can be lost since they may be confused with updates from branch instructions in the second group. Secondly, writes from wrong-path branch instructions to branch prediction write queue 120 may be allowed to update BHT 106 and BPT 108, due to inaccurate restoration of allocation pointer 124 on a branch misprediction after the wraparound. The inaccurate restoration may be due to the confusion between which branch instruction, the one in the first group or the one in the second group, associated with the same value of allocation pointer 122, made the update. For example, some wrong-path updates may remain in the branch prediction write queue 120, between retirement pointer 122 and allocation pointer 124, after a branch misprediction recovery.

The above undesirable situations may be avoided in several ways in exemplary aspects of this disclosure. For example, in one aspect, future branch instructions may not be fetched or fetching of future branch instructions can be stalled if allocation pointer 124 wraps around branch prediction write queue 120 (i.e., reaches the bottom-most entry of the circular buffer or stack comprising branch prediction write queue 120 and wraps around to the top-most entry) and reaches or coincides with retirement pointer 122 following the wraparound. Stalling fetching future branch instructions in this manner prevents a wrap over and correspondingly forecloses the possibility of wrong-path updates residing between entries pointed to by retirement pointer 122 and allocation pointer 124 if allocation pointer 124 wraps over. In another aspect, if allocation pointer 124 wraps over retirement pointer 122, future branch instructions fetched after the wrap over occurs are not associated with values of allocation pointer 124.

In yet another aspect, no specific mechanism to prevent the above two undesirable scenarios is adopted, thus potentially allowing wrong-path branch instructions to update BHT 106 and BPT 108. It is noted that for implementations of branch prediction write queue 120 with a large number of entries, the wraparound condition may occur when there is a long-latency event blocking retirement of branch instructions and all the branch instructions fetched following the oldest branch instruction are being correctly predicted (i.e., no restoration of allocation pointer 124 occurs due to a branch instruction being mispredicted). However, such situations are likely to be rare and overwriting entries of branch prediction write queue 120 updated with correctly predicting branch instructions, while also allowing some wrong-path updates to the branch prediction mechanism may not have any significant impact on performance.

Accordingly, in exemplary aspects, branch prediction write queue 120 may be configured to accelerate updates of BHT 106 and state machines in BPT 108, while mitigating or eliminating wrong-path updates in most cases.

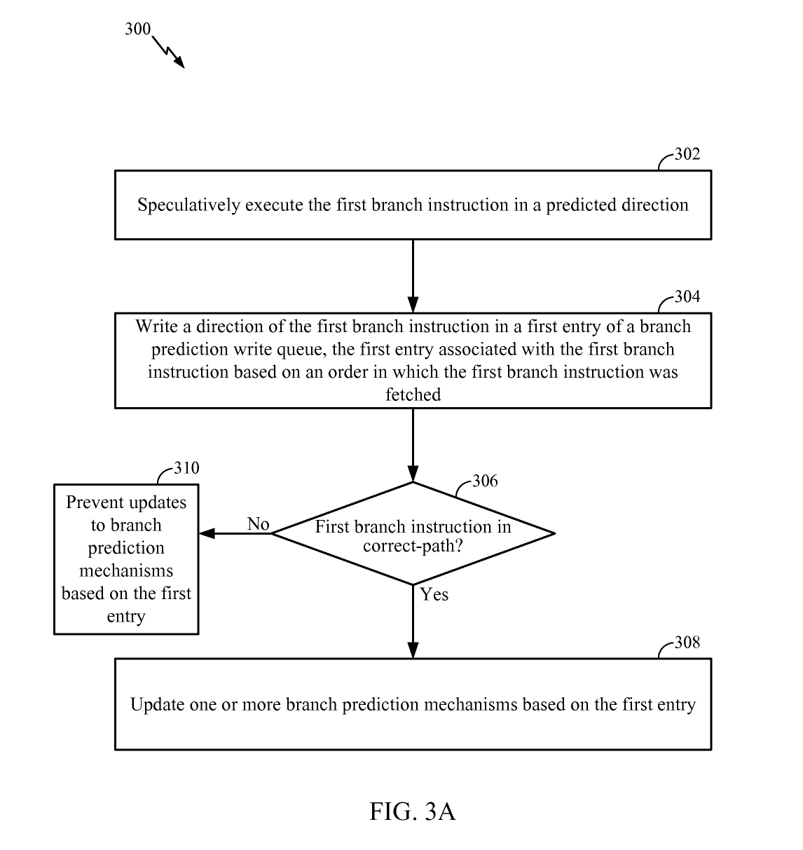

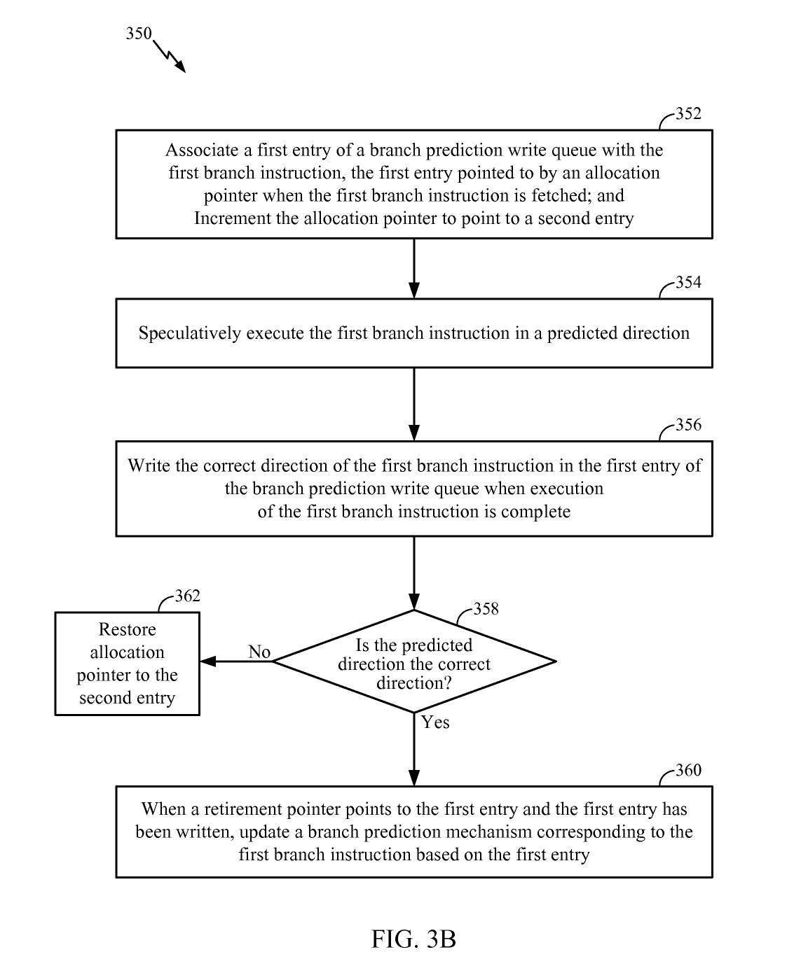

It will be appreciated that aspects include various methods for performing the processes, functions and/or algorithms disclosed herein. With reference to FIG. 3A, method 300 is illustrated, where method 300 generally relates to ordering updates from branch instructions using the exemplary branch prediction write queue 120, and accordingly preventing wrong-path updates of branch prediction mechanisms. FIG. 3B illustrates method 350 which depicts aspects related to the allocation and retirement pointers associated with a first branch instruction which is assumed to be in a correct-path.

Accordingly with reference to FIG. 3A, method 300 includes Block 302 for speculatively executing a first branch instruction. Upon the speculative execution of the first branch instruction in Block 302, method 300 proceeds to Block 304 for writing a direction of the first branch instruction (e.g., taken/not-taken) in a first entry (e.g., Br1) of a branch prediction write queue (e.g., 120), the first entry associated with the first branch instruction based on an order in which the first branch instruction was fetched (e.g., based on associating Br1 in branch prediction write queue 120 to which allocation pointer 124 points when the first branch instruction was fetched).

Method 300 then proceeds to Decision Block 306 for determining whether the first branch instruction was speculatively executed in a wrong-path or a correct-path. For example, the first branch instruction would have been speculatively executed in the correct-path if an older branch instruction fetched before the first branch instruction was not mispredicted. The first branch instruction would have been speculatively executed in the wrong-path if the older branch instruction fetched before the first branch instruction was mispredicted.

If the first branch instruction was speculatively executed in the correct-path, method 300 proceeds to Block 308 for updating one or more branch prediction mechanisms based on the first entry (e.g., updating BHT 106 and BPT 108 based on the direction of the first branch instruction stored in Br1, when retirement pointer 122 points to Br1, given that Br1 has not been flushed from branch prediction write queue 120 for being in a wrong-path).

On the other hand, if the first branch instruction was speculatively executed in a wrong-path, method 300 proceeds to Block 310 for preventing updates to the one or more branch prediction mechanisms based on the first entry, (e.g., if an older branch instruction which is older than Br1 had been mispredicted, then the first branch instruction would have been executed in a wrong-path and by restoring allocation pointer to an entry logically equal to or before Br1 upon the older branch instruction's misprediction, the first information stored in Br1 would have been flushed).

With reference now to FIG. 3B, method 350 is provided which starts with the assumption that the first branch instruction of method 300 is in a correct-path (e.g., is the oldest branch instruction corresponding to entry Br1 in branch prediction write queue 120). This assumption is checked in Block 358, as explained below.

In method 350, Block 352 comprises associating a first entry of a branch prediction write queue with a first branch instruction, the first entry pointed to by an allocation pointer when the first branch instruction is fetched. For example, a first entry Br1 of branch prediction write queue 120 pointed to by allocation pointer 124 is associated with the first branch instruction, when the first branch instruction is fetched. Allocation pointer 124 is incremented after it is read and associated with the first branch instruction in Block 352. Allocation pointer 124 is incremented to point to a second entry, where the second entry may be logically one entry after the first entry, keeping in mind situations such as the wraparound condition as explained above.

Moving on to Block 354, method 350 includes speculatively executing the first branch instruction in a predicted direction. For example, in processor 110, a prediction for the first branch instruction may be available from the branch prediction mechanism which includes BHT 106 and BPT 108, based on which the first branch instruction may be speculatively executed in instruction pipeline 112.

In Block 356, when execution of the first branch instruction is completed, information related to a direction of the first branch instruction is written to the first entry of the branch prediction write queue. For example, when execution of the first branch instruction is completed in the EX2/EX3 pipeline stage of instruction pipeline 112, the direction (taken/not-taken) of the first branch instruction, e.g., as obtained from result 115 of the execution for the first branch instruction is written to the first entry Br1 of branch prediction write queue 120. Further, a status bit may be set to indicate that the first entry Br1 has been written.

Method 350 includes Decision Block 358, where it is checked whether the prediction for the first branch instruction is correct. If the predicted direction is the correct direction, method 350 proceeds to Block 360. In Block 360, one or more branch prediction mechanisms are trained based on the information related to the first branch instruction in the first entry, if the first entry has been written and its status bit has been set, when a retirement pointer points to the first entry. For example, one or more branch prediction mechanisms including BHT 106 and branch prediction state machines in BPT 108 may be trained based on the correct direction of the first branch instruction when retirement pointer 122 points to the first entry Br1, and given that the first entry Br1 has been written, as indicated by an associated status bit, for example.

On the other hand, if in Decision Block 358, it is determined that there was a misprediction or that the predicted direction of the first branch instruction is not the correct direction of the first branch instruction, method 350 proceeds to Block 362. In Block 362, the allocation pointer is restored to point to the second entry. Restoring allocation pointer 124 to point to the second entry which is logically one entry after the first entry may have the effect of flushing writes from any younger instructions following the first branch instruction from branch prediction write queue 120.

Additionally it will be understood that disclosed aspects also include a processing system (e.g., processing system 110) comprising means for performing the various functions above. For example, an exemplary processing system can include means for speculatively executing a first branch instruction (e.g., instruction pipeline 102 of processor 110). The processing system can further include means for storing a direction of the first branch instruction in an order in which the first branch instruction was fetched (e.g., the first entry Br1 of branch prediction write queue 120 using the aforementioned allocation pointer 124). Further, the processing system may comprise means for updating one or more branch prediction mechanisms based on the stored direction of the first branch instruction if the first branch instruction was speculatively executed in a correct-path (e.g., branch prediction write queue 120 configured to update (e.g., BHT 106 and BPT 108 when retirement pointer 122 points to Br1 and Br1 has been written with the direction of the first branch instruction). The processing system also includes means for preventing updates to the one or more branch prediction mechanisms based on the stored direction of the first branch instruction if the first branch instruction was speculatively executed in a wrong-path (e.g., branch prediction write queue configured to restore allocation pointer 124 to flush wrong-path writes to branch prediction write queue 120, thus preventing the wrong-path writes to update the branch prediction mechanisms).

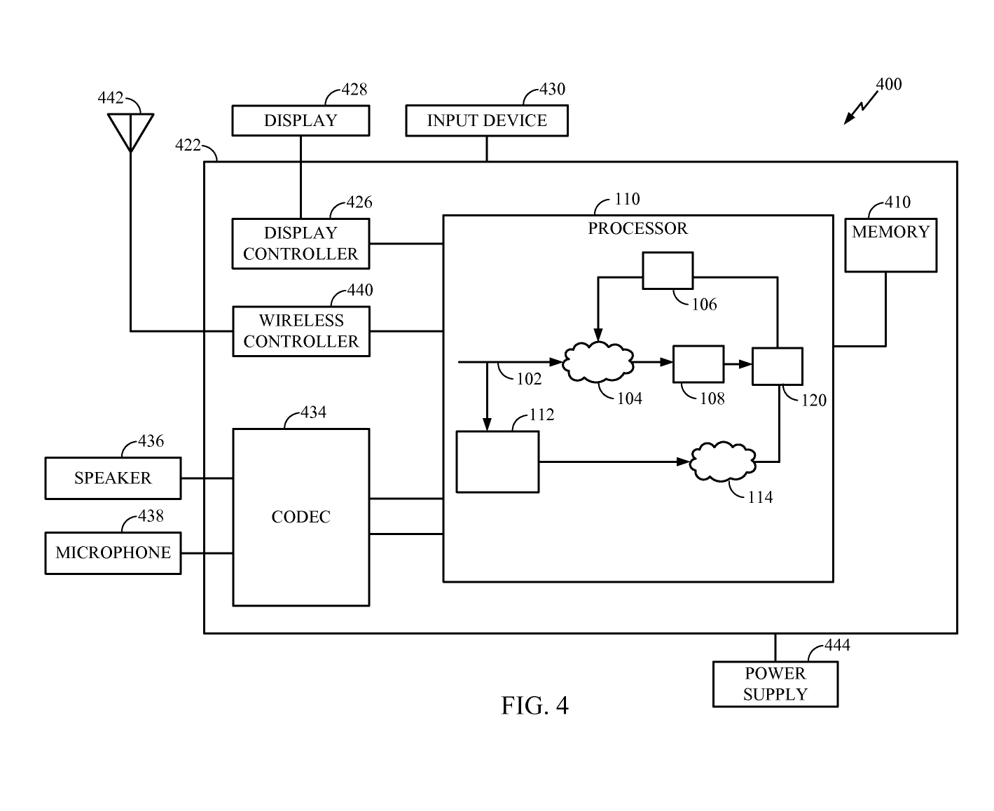

Referring now to FIG. 4, a block diagram of a wireless device that is configured according to exemplary aspects is depicted and generally designated 400. Wireless device 400 includes processor 110 of FIG. 1, comprising BHT 106, BPT 108, BPT index 104, branch prediction write queue 120, execution pipeline 112, and prediction check block 114 as discussed above. Processor 110 may be communicatively coupled to memory 410. An instruction cache is not explicitly shown in this view but may be part of processor 110 or may be a separate block coupled between processor 110 and memory 410 as known in the art. Wireless device 400 may be configured to perform the methods of FIGS. 3A-B, and may further be configured to execute instructions retrieved from memory 410 in order to perform the methods of FIGS. 3A-B in some aspects.

FIG. 4 also shows display controller 426 that is coupled to processor 110 and to display 428. Coder/decoder (CODEC) 434 (e.g., an audio and/or voice CODEC) can be coupled to processor 110. Other components, such as wireless controller 440 (which may include a modem) are also illustrated. Speaker 436 and microphone 438 can be coupled to CODEC 434. FIG. 4 also indicates that wireless controller 440 can be coupled to wireless antenna 442. In a particular aspect, processor 110, display controller 426, memory 410, CODEC 434, and wireless controller 440 are included in a system-in-package or system-on-chip device 422.

In a particular aspect, input device 430 and power supply 444 are coupled to the system-on-chip device 422. Moreover, in a particular aspect, as illustrated in FIG. 4, display 428, input device 430, speaker 436, microphone 438, wireless antenna 442, and power supply 444 are external to the system-on-chip device 422. However, each of display 428, input device 430, speaker 436, microphone 438, wireless antenna 442, and power supply 444 can be coupled to a component of the system-on-chip device 422, such as an interface or a controller.

It should be noted that although FIG. 4 depicts a wireless communications device, processor 110 and memory 410 may also be integrated into a set-top box, a music player, a video player, an entertainment unit, a navigation device, a personal digital assistant (PDA), a fixed location data unit, a computer, a laptop, a tablet, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer readable media embodying a method for mitigating wrong-path effects in branch prediction. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of operating a processor, the method comprising:
upon speculatively executing a first branch instruction, writing a direction of the first branch instruction in a first entry of a branch prediction write queue, the first entry associated with the first branch instruction based on an order in which the first branch instruction was fetched;
updating one or more branch prediction mechanisms based on the first entry if the first branch instruction was speculatively executed in a correct-path; and
preventing updates to the one or more branch prediction mechanisms based on the first entry if the first branch instruction was speculatively executed in a wrong-path.

2. The method of claim 1 comprising updating one or more branch prediction mechanisms based on the first entry if the first branch instruction was speculatively executed in a correct-path, prior to committing the first branch instruction.

3. The method of claim 1, further comprising updating a status bit associated with the first entry to indicate that the first entry was written.

4. The method of claim 1, wherein, the first branch instruction was speculatively executed in the correct-path if an older branch instruction fetched before the first branch instruction was not mispredicted and the first branch instruction was speculatively executed in the wrong-path if the older branch instruction fetched before the first branch instruction was mispredicted.

5. The method of claim 1, wherein, associating the first entry with the first branch instruction is based on an allocation pointer pointing to the first entry when the first branch instruction was fetched.

6. The method of claim 5, further comprising:
incrementing the allocation pointer to point to a second entry after associating the first entry with the first branch instruction.

7. The method of claim 6, wherein if the first branch instruction was mispredicted, restoring the allocation pointer to point to the second entry.

8. The method of claim 7, wherein restoring the allocation pointer to point to the second entry causes flushing writes in the branch prediction write queue from wrong-path branch instructions comprising programmatically younger instructions which were fetched after the first branch instruction.

9. The method of claim 6, further comprising associating the second entry with a second branch instruction which was fetched after the first branch instruction was fetched.

10. The method of claim 5, comprising updating one or more branch prediction mechanisms based on the first entry if the first branch instruction was speculatively executed in a correct-path, when a retirement pointer of the branch prediction write queue points to the first entry and the first entry has been written,
wherein, the retirement pointer points to a retirement entry corresponding to an oldest branch instruction in an instruction pipeline of the processor at any given time, and wherein the retirement pointer is incremented if the retirement entry is written with a direction of the oldest branch instruction and the oldest branch instruction is a correct-path branch instruction.

11. The method of claim 10, wherein the branch prediction write queue is a circular stack or buffer.

12. The method of claim 11, further comprising stalling fetching future branch instructions if the allocation pointer wraps around the branch prediction write queue and coincides with the retirement pointer.

13. The method of claim 11, further comprising avoiding associating the allocation pointer with future branch instructions if the allocation pointer wraps over the retirement pointer.

14. A processor comprising:
an instruction pipeline to speculatively execute a first branch instruction;
a branch prediction write queue comprising a first entry to store a direction of the first branch instruction, the first entry associated with the first branch instruction based on an order in which the first branch instruction was fetched in the instruction pipeline;
wherein the branch prediction write queue is configured to update one or more branch prediction mechanisms based on the first entry if the first branch instruction was speculatively executed in a correct-path; and
wherein the a branch prediction write queue is configured to prevent updates to the one or more branch prediction mechanisms based on the first entry if the first branch instruction was speculatively executed in a wrong-path.

15. The processor of claim 14 wherein the branch prediction write queue is configured to update the one or more branch prediction mechanisms based on the first entry if the first branch instruction was speculatively executed in a correct-path, before the first branch instruction is committed.

16. The processor of claim 14, wherein the branch prediction write queue further comprises a status bit associated with the first entry to indicate that the first entry was written.

17. The processor of claim 14, wherein, the first branch instruction was speculatively executed in the correct-path if an older branch instruction fetched before the first branch instruction was not mispredicted and the first branch instruction was speculatively executed in the wrong-path if the older branch instruction fetched before the first branch instruction was mispredicted.

18. The processor of claim 14, wherein, the branch prediction write queue comprises an allocation pointer to point to the first entry when the first branch instruction was fetched.

19. The processor of claim 18, wherein the allocation pointer is incremented to point to a second entry after the first entry is associated with the first branch instruction.

20. The processor of claim 19, wherein the allocation pointer is restored to point to the second entry if the first branch instruction was mispredicted.

21. The processor of claim 20, wherein writes in the branch prediction write queue from wrong-path branch instructions comprising programmatically younger instructions which were fetched after the first branch instruction are flushed when the allocation pointer is restored to point to the second entry.

22. The processor of claim 19, wherein the second entry is associated with a second branch instruction which was fetched after the first branch instruction was fetched.

23. The processor of claim 18, wherein the branch prediction write queue is configured to update one or more branch prediction mechanisms based on the first entry if the first branch instruction was speculatively executed in a correct-path, when a retirement pointer of the branch prediction write queue points to the first entry and the first entry has been written,
wherein, the retirement pointer points to a retirement entry corresponding to an oldest branch instruction in an instruction pipeline of the processor at any given time, and wherein the retirement pointer is incremented if the retirement entry is written with a direction of the oldest branch instruction and the oldest branch instruction is a correct-path branch instruction.

24. The processor of claim 23, wherein the branch prediction write queue is a circular stack or buffer.

25. The processor of claim 24, configured to not fetch future branch instructions if the allocation pointer wraps around the branch prediction write queue and coincides with the retirement pointer.

26. The processor of claim 24, wherein the allocation pointer is not associated with future branch instructions if the allocation pointer wraps over the retirement pointer.

27. A processing system comprising:
means for speculatively executing a first branch instruction;
means for storing a direction of the first branch instruction in an order in which the first branch instruction was fetched;
means for updating one or more branch prediction mechanisms based on the stored direction of the first branch instruction if the first branch instruction was speculatively executed in a correct-path; and
means for preventing updates to the one or more branch prediction mechanisms based on the stored direction of the first branch instruction if the first branch instruction was speculatively executed in a wrong-path.

28. The method of claim 1 wherein the means for updating comprises means for updating the one or more branch prediction mechanisms before the first branch instruction is committed.

29. A non-transitory computer readable storage medium comprising code, which, when executed a processor, causes the processor to perform operations for preventing wrong-path updates to branch prediction mechanisms, the non-transitory computer readable storage medium comprising:
code for speculatively executing a first branch instruction;
code for writing a direction of the first branch instruction in a first entry of a branch prediction write queue, the first entry associated with the first branch instruction based on an order in which the first branch instruction was fetched;
code for updating one or more branch prediction mechanisms based on the first entry if the first branch instruction was speculatively executed in a correct-path; and
code for preventing updates to the one or more branch prediction mechanisms based on the first entry if the first branch instruction was speculatively executed in a wrong-path.

30. The non-transitory computer readable storage medium of claim 29, comprising code for updating the one or more branch prediction mechanisms based on the first entry if the first branch instruction was speculatively executed in a correct-path, prior to committing the first branch instruction.
